(19) United States
(12) Patent Application Publication
(10) Pub. No.: US 2011/0052300 A1
(43) Pub. Date: Mar. 3, 2011

(54) CUTTING APPARATUS AND RECORDING APPARATUS

(75) Inventors: Shoji AKATSU, Shiojiri-shi (JP); Eiji KUMAI, Matsumoto-shi (JP)

(73) Assignee: SEIKO EPSON CORPORATION, Tokyo (JP)

(21) Appl. No.: 12/862,008

(22) Filed: Aug. 24, 2010

(30) Foreign Application Priority Data
Aug. 25, 2009 (JP) 2009-194566

(51) Int. Cl. B41J 11/66; B26D 7/01

(52) U.S. Cl. 400/621; 83/467.1

(57) ABSTRACT

A cutting apparatus includes: a restricting member that is provided downstream of an ejector that ejects a recording target medium after recording processing, the restricting member restricting a position in height of the ejected recording target medium; and a cutting unit that is also provided downstream of the ejector and moves in a width direction, which is orthogonal to a direction of ejection of the recording target medium, to cut the recording target medium, wherein the restricting member moves between a first position that is located inside a path of movement of the cutting unit and a second position that is located outside the path of movement of the cutting unit.

Japanese Patent Application No. 2009-194566 filed Aug. 25, 2009 is incorporated by reference in its entirety herein.

### BACKGROUND

1. Technical Field

The present invention relates to a cutting apparatus and a recording apparatus.

2. Related Art

An ink-jet printer disclosed in Japanese Patent No. 3,867,779 is known as an example of a recording apparatus that performs recording on a recording target medium. The ink-jet printer disclosed in Japanese Patent No. 3,867,779 is configured to be able to perform recording on a roll sheet. The disclosed ink-jet printer is equipped with a cutting apparatus for cutting (i.e., shearing) a roll sheet into a piece that has a predetermined size at a time. The cutting apparatus is provided downstream of an ejection unit that ejects the roll sheet after the recording process. The cut pieces of roll paper are stacked on a stacker or the like. The stacker is provided downstream of the cutting apparatus.

Generally, at a position downstream of an ejection unit, a part of a roll sheet sometimes gets raised because of the tendency of the roll sheet itself to curl back into an original rolled form, the collision of the roll sheet before cutting with stacked sheets of roll paper, or due to other reasons. Hereinafter, such a partially raised state of a roll sheet is referred to as “loop-like raised state”. When a roll sheet is put into a loop-like raised state, it is displaced from a position where it can be cut into a piece. When a cutting apparatus performs cutting operation, there is a risk that a cutter unit of the cutting apparatus collides with the displaced roll sheet, which results in a paper jam failure. To prevent a roll sheet from being put into a loop-like raised state, in some known configurations, a restricting member such as a stopper that restricts the position in height of an ejected roll sheet is provided downstream of an ejection unit. However, a position where such loop-like raising of a roll sheet occurs varies depending on the specification of an apparatus. In some cases, an optimum position where a restricting member can prevent the loop-like raising of a roll sheet most effectively is located inside a path of movement of a cutter unit, which obstructs cutting operation.

### SUMMARY

An advantage of some aspects of the invention is to provide a cutting apparatus that prevents a recording target medium from being put into a loop-like raised state effectively without obstructing cutting operation and to provide a recording apparatus that is equipped with such a cutting apparatus.

In order to address the above-identified problem without any limitation thereto, a cutting apparatus according to a first aspect of the invention includes: a restricting member that is provided downstream of an ejector that ejects a recording target medium after recording processing, the restricting member restricting a position in height of the ejected recording target medium; and a cutting unit that is also provided downstream of the ejector and moves in a width direction, which is orthogonal to a direction of ejection of the recording target medium, to cut the recording target medium, wherein the restricting member moves between a first position that is located inside a path of movement of the cutting unit and a second position that is located outside the path of movement of the cutting unit.

With such a structure, since the restricting member is able to move between the position inside the path of movement of the cutting unit and the position outside the path of movement of the cutting unit, it is possible to prevent the loop-like raising of the recording target medium effectively inside the path of movement of the cutting unit during the ejection of the recording target medium and to get the restricting member out of the way, that is, move it to the outside of the path of movement of the cutting unit, during the cutting of the recording target medium.

In the structure of a cutting apparatus according to the first aspect of the invention, it is preferable that the restricting member should move between the first position and the second position as the cutting unit moves.

With such a preferred structure, the restricting member can work in conjunction with the cutting unit in a well-coordinated manner; for example, it is possible to prevent the loop-like raising of the recording target medium effectively inside the path of movement of the cutting unit during the ejection of the recording target medium and to get the restricting member out of the way, that is, move it to the outside of the path of movement of the cutting unit, during the cutting of the recording target medium.

In the structure of a cutting apparatus according to the first aspect of the invention, it is preferable that the restricting member should be provided in substantially perpendicular orientation and/or in an at least partially suspended manner in a state in which the restricting member can rotate around a predetermined shaft; and the restricting member should move from the first position to the second position when the cutting unit is brought into contact with, and applies a pushing force to, the restricting member.

When the cutting unit performs cutting operation, it is brought into contact with the restricting member to push the restricting member out of the way, thereby moving the restricting member from the first position to the second position. Therefore, with the preferred structure, it is possible to move the restricting member by utilizing the motive power of the cutting unit without any need to provide a means for supplying motive power to the restricting member.

In the preferred structure described above, the restricting member may have an inclined plane for producing a force for moving the restricting member from the first position to the second position when the cutting unit is brought into contact with, and applies the pushing force to, the inclined plane.

With such a preferred structure, the cutting unit can push the restricting member out of the way smoothly.

Preferably, the first position is a position at which the restricting member is in a stable state due to its own weight. The second position is preferably a position at which the restricting member is in a state in which a moving force toward the first position is exerted on the restricting member due to its own weight.

With such a preferred structure, the restricting member, which has been pushed out of the way, automatically moves back to its optimum position at which the loop-like raising of the recording target medium can be prevented most effectively, due to its own weight.

In the structure of a cutting apparatus according to the first aspect of the invention, it is preferable that the restricting member should include a roller that can rotate around a shaft extending in the width direction; and the roller should be provided at a position for restricting the position in height of the recording target medium.

When the roller is brought into contact with the recording target medium, a frictional force that acts between the roller and the recording target medium is converted into a force for rotary motion of the roller. Therefore, with the preferred structure, the recording target medium will not be scratched.

In the structure of a cutting apparatus according to the first aspect of the invention, it is preferable that the restricting member should include a plurality of member portions that are arranged along the path of movement of the cutting unit; and the member portions should be configured to be able to move independently of one another.

With such a preferred structure, during cutting operation, when the cutting unit is brought into contact with a certain member portion of the restricting member to push this member portion out of the way, the other member portions of the restricting member that are not in contact with the cutting unit remain at the first position, thereby preventing the loop-like raising of the recording target medium effectively inside the path of movement of the cutting unit. Therefore, the preferred structure makes it possible to prevent the loop-like raising of the recording target medium inside the path of movement of the cutting unit effectively even during cutting operation.

A recording apparatus according to a second aspect of the invention includes: a recording section that performs recording on a recording target medium; an ejecting section that ejects the recording target medium after the recording; and the cutting apparatus according to the first aspect of the invention, wherein the cutting apparatus is provided downstream of the ejecting section.

### BRIEF DESCRIPTION OF THE DRAWINGS

The invention will be described with reference to the accompanying drawings, wherein like numbers reference like elements.

FIG. 1 is a diagram that schematically illustrates an example of the structure of a recording apparatus according to a first embodiment of the invention.

FIG. 2 is a front view that schematically illustrates an example of the structure of a cutting apparatus according to the first embodiment of the invention, which is viewed from an ejection side along the direction of ejection.

FIG. 3 is a perspective view that schematically illustrates a restricting member and a cutter unit before cutting operation according to the first embodiment of the invention.

FIG. 4 is a perspective view that schematically illustrates the restricting member and the cutter unit during cutting operation according to the first embodiment of the invention.

FIG. 5 is a side view that schematically illustrates an example of the structure of the cutting apparatus according to the first embodiment of the invention, which is viewed along the direction of a width.

FIG. 6 is a side view that schematically illustrates an example of the operation of the restricting member according to the first embodiment of the invention.

FIGS. 7A and 7B are a set of diagrams that schematically illustrates an example of the operation of the cutting apparatus according to the first embodiment of the invention.

FIG. 8 is a front view that schematically illustrates an example of the structure of a cutting apparatus according to a second embodiment of the invention, which is viewed from an ejection side along the direction of ejection.

FIG. 9 is a perspective view that schematically illustrates a restricting member and a cutter unit during cutting operation according to the second embodiment of the invention.

### DESCRIPTION OF EXEMPLARY EMBODIMENTS

With reference to the accompanying drawings, a cutting apparatus and a recording apparatus according to an exemplary embodiment of the invention will now be explained in detail. Where necessary, different scales are used for members illustrated in each of the accompanying drawings that are referred to in the following explanation so that each of the members illustrated therein has a size that can be recognized easily. As an example of a recording apparatus according to an aspect of the invention, a large type ink-jet printer that can perform printing on a sheet of recording paper that has a comparatively large size (e.g., A1 paper or B1 paper conforming to the JIS Standard, a roll sheet, or the like) (a large format printer: LFP) is described in the present embodiment of the invention. Large recording paper described below is an example of a recording target medium according to an aspect of the invention.

### First Embodiment

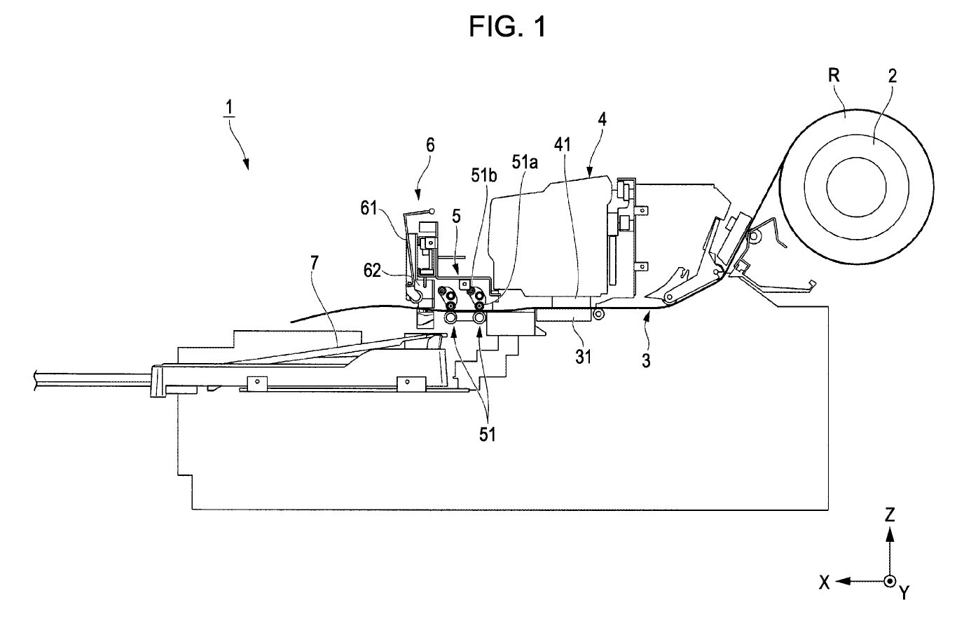

FIG. 1 is a diagram that schematically illustrates an example of the structure of an ink-jet printer 1 according to an exemplary embodiment of the invention. As illustrated in FIG. 1, the ink-jet printer 1 includes a spindle 2, a sheet movement path 3, a recording unit 4, an ejection unit 5, a cutting device 6, and a stacker 7. A sheet of paper (recording target medium) is formed as a roll R on the spindle 2. The roll sheet R is fed along the sheet movement path 3. The recording unit 4 performs recording on the incoming part of the roll sheet R. The ejection unit 5 ejects the roll sheet R after the recording process. The cutting device 6 cuts the roll sheet R ejected from the ejection unit 5 into a piece at a time. The cut pieces of roll paper are stacked on the stacker 7. The ink-jet printer 1 is further provided with a control unit that is not illustrated in the drawing. As an integrated controller, the control unit controls the operation of each of the above components. In the following description, the direction of feeding of the roll sheet R, which is the direction of ejection thereof, may be referred to as X-axis direction. The direction of the width of the sheet movement path 3, which is orthogonal to the X-axis direction, may be hereinafter referred to as Y-axis direction. The Y-axis direction is shown as a perpendicular direction with respect to the sheet face of FIG. 1. The direction orthogonal to both the X-axis direction and the Y-axis direction may be hereinafter referred to as Z-axis direction.

The spindle 2 that can rotate around a shaft that extends in the Y-axis direction supports the roll sheet R. The spindle 2 is provided at a predetermined height in the negative X side of the ink-jet printer 1. The sheet movement path 3 includes a sheet movement route on which the roll sheet R can be moved along the X-Y plane (i.e., horizontal plane). A platen 31 is provided on the sheet movement route at a position where it faces a recording head 41 of the recording unit 4. The platen 31 holds the roll sheet R in the horizontal position during movement thereon. A plurality of feeding rollers is provided along the sheet movement path 3. The feeding rollers rotate while nipping the roll sheet R to feed it.

The recording unit 4 is provided with the recording head 41 mentioned above. The recording head 41 ejects ink onto the incoming part of the roll sheet R that is fed along the sheet movement path 3. The recording head 41 is mounted on a carriage that can travel in the direction of the width of the sheet movement path 3. The recording head 41 has a plurality of nozzle lines. Ink of the corresponding one of predetermined colors is ejected from each of the plurality of nozzle lines. For example, yellow ink (Y), magenta ink (M), cyan ink (C), and black ink (K) are ejected from the nozzle lines. The recording head 41 ejects ink onto the recording surface of the roll sheet R supported by the platen 31. By this means, the recording head 41 prints a predetermined image, characters, and/or the like on the recording surface. This processing is referred to as recording in this specification.

Having been subjected to recording at the recording unit 4, the roll sheet R is ejected from the ejection unit 5, which constitutes the end of the sheet movement path 3. The ejection unit 5 is equipped with a plurality of ejection rollers 51 that rotate while nipping the roll sheet R to eject it. The ejection roller 51 includes a roller-switching mechanism that selects one roller for nipping paper depending on the type of the paper. The switching is performed between a serrated roller 51a and a non-serrated roller 51b. In a case where paper that is to be ejected is the roll sheet R, which has a small thickness, the paper tends to stick to the ejection roller 51 through electrostatic forces or due to other reasons. Therefore, in such a case, the serrated roller 51a, which has a smaller contact area, is selectively used for nipping the paper. In a case where paper that is to be ejected is plain paper, which has a comparatively large thickness, the paper is less likely to stick to the ejection roller 51 because of its flexural rigidity. Therefore, in such a case, the non-serrated roller 51b, which has a larger contact area and thus is superior to the serrated roller 51a in terms of stable sheet ejection operation, is selectively used for nipping the paper.

The cutting device 6 that cuts the ejected roll sheet R into a piece that has a predetermined size at a time is provided downstream of the ejection unit 5. The cutting device 6 includes a restricting member 61 and a cutter unit 62. The restricting member 61 restricts the position in height of the ejected roll sheet R. The cutter unit 62 moves in the width direction (i.e., Y-axis direction), which is orthogonal to the direction of ejection of the roll sheet R (i.e., X-axis direction), to cut the roll sheet R. The stacker 7, which extends in the X-axis direction, is provided downstream of the cutting device 6. The pieces of the roll sheet R cut by the cutter unit 62 are stacked on the stacker 7.

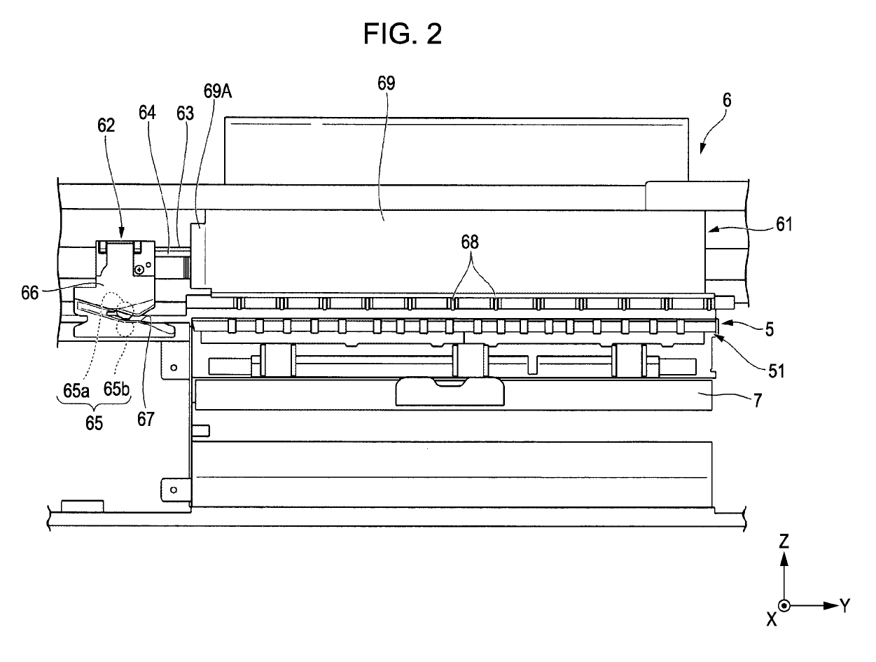

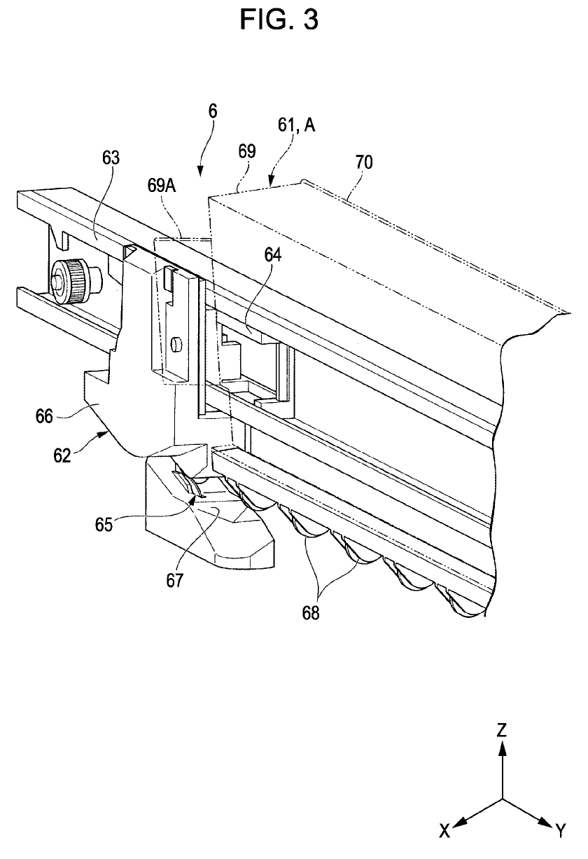

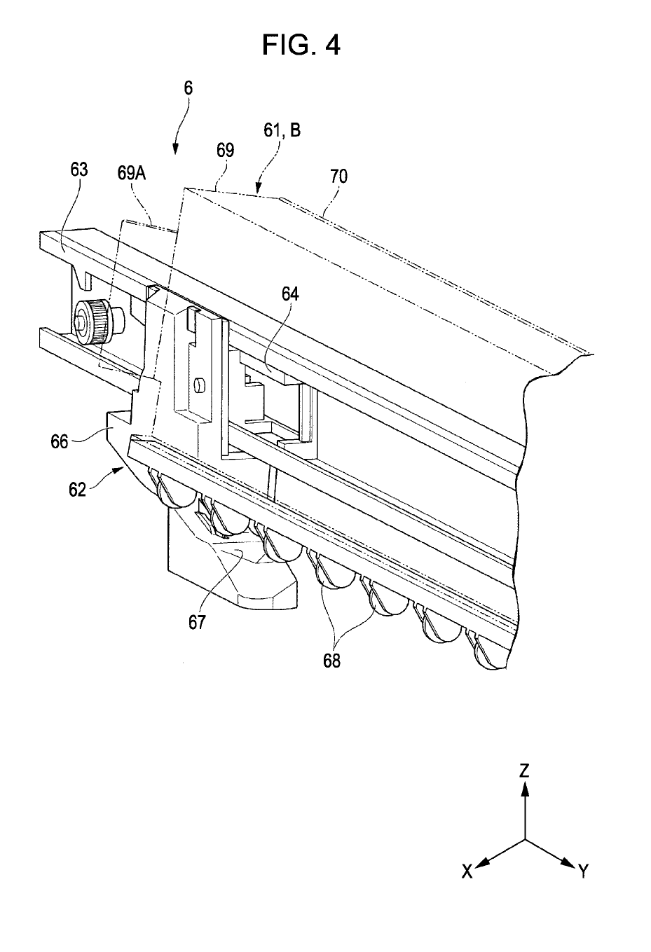

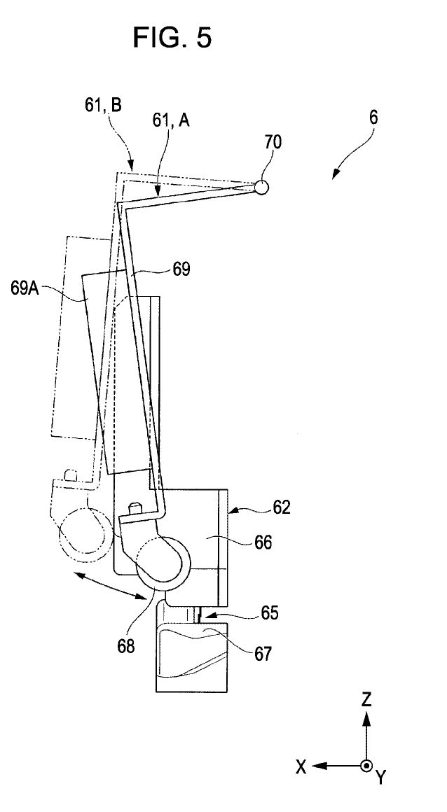

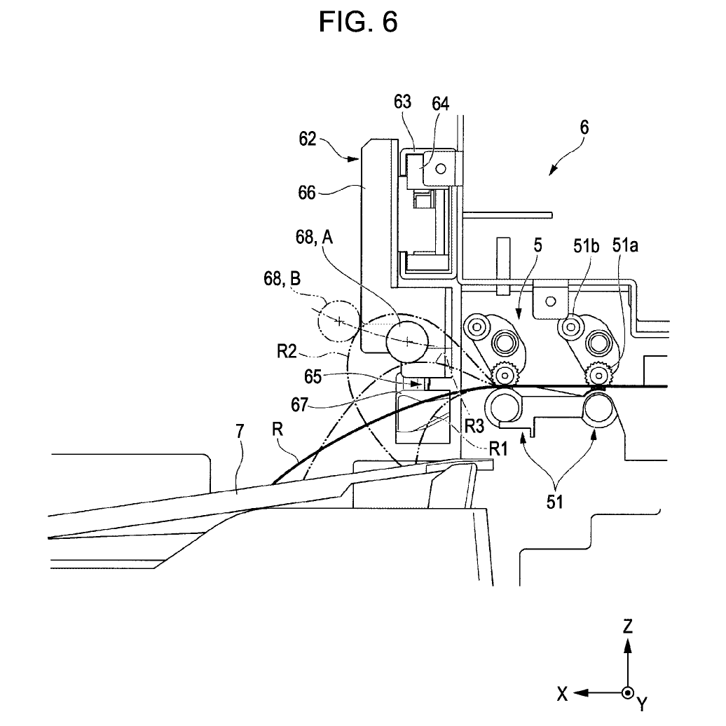

Next, with reference to FIGS. 2 to 6, the characteristic structure of the cutting device 6 according to the present embodiment of the invention is explained in detail. FIG. 2 is a front view that schematically illustrates an example of the structure of the cutting device 6 according to a first embodiment of the invention, which is viewed from the ejection side along the direction of ejection (i.e., X-axis direction). FIG. 3 is a perspective view that schematically illustrates the restricting member 61 and the cutter unit 62 before cutting operation according to the first embodiment of the invention. FIG. 4 is a perspective view that schematically illustrates the restricting member 61 and the cutter unit 62 during cutting operation according to the first embodiment of the invention. FIG. 5 is a side view that schematically illustrates an example of the structure of the cutting device 6 according to the first embodiment of the invention, which is viewed along the width direction (i.e., Y-axis direction). FIG. 6 is a side view that schematically illustrates an example of the operation of the restricting member 61 according to the first embodiment of the invention.

As illustrated in FIGS. 2 and 3, the cutter unit 62 is mounted on a carriage 64 that reciprocates along a guiding shaft 63 that extends in the width direction (i.e., Y-axis direction). The cutter unit 62 includes a cutter holder 66, which holds a pair of rotary blades (cutter blades) 65 for cutting the roll sheet R. An upper rotary blade 65a is a driving blade that rotates as the carriage 64 moves. A lower rotary blade 65b is a driven blade that is not provided with a driving mechanism of its own and thus rotates as the upper rotary blade 65a rotates. The cutter holder 66 includes a guiding path 67 that guides the roll sheet R into a cut position. The cut position is a position where a part of the upper rotary blade 65a and a part of the lower rotary blade 65b are disposed very close to each other in such a manner that they overlap in the X-axis direction.

The restricting member 61 includes a plurality of restricting rollers 68 (roller) that restricts the position in height of the ejected roll sheet R and a supporting plate 69 that supports the plurality of restricting rollers 68 while allowing the arc-drawing movement thereof. The supporting plate 69 extends in the Y-axis direction. The supporting plate 69 is provided in substantially perpendicular orientation in a partially suspended manner at a predetermined height. As illustrated in FIGS. 3, 4, and 5, the supporting plate 69 has a shape that resembles the letter L in a section. Supported by a turning fulcrum shaft 70, which is provided above the guiding shaft 63 inside a body case that is not illustrated in the drawing, the supporting plate 69 rotates around the Y axis as a pivotable plate. The plurality of restricting rollers 68 is fixed at the arc-drawing end of the supporting plate 69.

More specifically, the restricting rollers 68 are arranged next to one another in the Y-axis direction at predetermined intervals at the arc-drawing end of the supporting plate 69. Each of the restricting rollers 68 can rotate around the Y axis. The restricting rollers 68 are brought into contact with the roll sheet R ejected from the ejection unit 5 so as to restrict the position in height of the roll sheet R. When the restricting rollers 68 are brought into contact with the roll sheet R, they convert a frictional force that acts between them and the roll sheet R into a force for rotary motion. By this means, it is possible to prevent the roll sheet R from being scratched.

The restricting member 61 having the above structure is allowed to move between a first position and a second position. The first position is located inside the path of movement of the cutter unit 62. The first position is denoted as A in FIG. 5. The second position is located outside the path of movement of the cutter unit 62. The second position is denoted as B in FIG. 5. When the restricting member 61 is positioned at the first position A, it is in a stable state due to its own weight. In addition, according to the positional design of the present embodiment of the invention, when the restricting rollers 68 are set at the first position A, which is an optimum position, they can prevent the loop-like raising of the roll sheet R most effectively. A more detailed explanation thereof will be given later with reference to FIG. 6. When the restricting member 61 is positioned at the second position B, it is in a state in which a moving force toward the first position A is exerted on the restricting member 61 due to its own weight. When the restricting rollers 68 are set at the second position B, they are positioned in the vicinity of the optimum position, that is, the position at which the loop-like raising of the roll sheet R can be prevented most effectively. A more detailed explanation thereof will be given later with reference to FIG. 6.

When the cutter unit 62 performs cutting operation, it is brought into contact with the restricting member 61 to push the restricting member 61 out of the way. As illustrated in FIGS. 3 and 4, since the cutter unit 62 pushes the restricting member 61, the restricting member 61 moves from the first position A to the second position B. The supporting plate 69 has an inclined plane (e.g., slope) at its negative Y end portion 69A. When the cutter unit 62 applies a pushing force to the inclined −Y side portion 69A, a force for moving the restricting member 61 from the first position A to the second position B is produced. The side portion 69A is inclined in an orientation in which its relative −Y side is relatively distant from the ejection unit 5, which means that its relative −Y side is positioned at its relative +X side. In addition, when positioned at the first position A, a part of the side portion 69A extends to the outside of the path of movement of the cutter unit 62 as illustrated in FIG. 5.

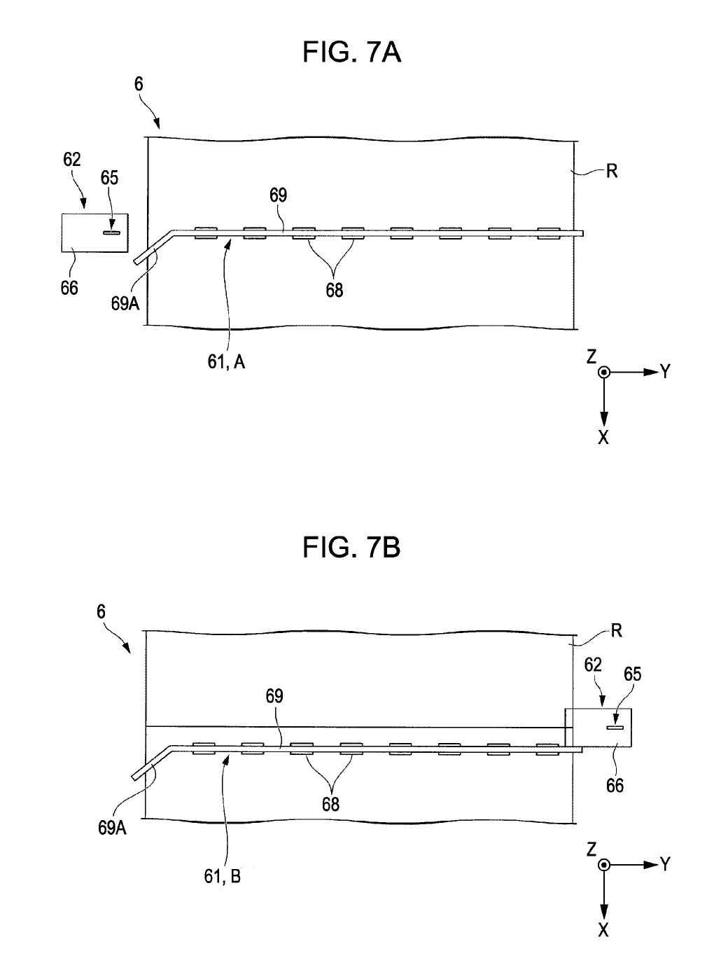

Next, with reference to FIG. 7, the operation of the cutting device 6 according to the present embodiment of the invention is explained in detail. FIGS. 7A and 7B are a set of diagrams that schematically illustrates an example of the operation of the cutting device 6 according to the first embodiment of the invention. As illustrated in FIG. 7A, the cutter unit 62 is in a standby state before the start of cutting operation at a −Y side position outside the sheet movement route on which the roll sheet R can be moved. When the cutter unit 62 is in a standby state, the restricting member 61, which includes the hanging plate, is positioned at the first position A, which is located inside the path of movement of the cutter unit 62. When the restricting member 61 is set at the first position A, the restricting rollers 68 prevent the roll sheet R from getting partially raised to any position above restricting positions, which are the positions of the restricting rollers 68.

Generally, the thickness of the roll sheet R is small. In addition, the roll sheet R has a tendency to curl back into an original rolled form. For these reasons, as illustrated in FIG. 6, for example, in a case where the leading edge of the roll sheet R ejected from the ejection unit 5 is brought into contact with the stacker 7, a force for changing the form (i.e., position) of the roll sheet R from R1 to R2 is exerted on the roll sheet R during its movement. As a result, the roll sheet R would be put into a loop-like raised state shown as R2 if such looping deformation were not restricted by any preventive means. If the roll sheet R were put into the loop-like raised state R2, it would be displaced from a position where the cutter unit 62a can cut it into a piece. When cutting operation were performed in such a state, the cutter holder 66 of the cutter unit 62a might collide with the displaced roll sheet R, which results in a paper jam failure.

In contrast, in the present embodiment of the invention, when the restricting member 61 is set at the first position A, the restricting rollers 68 are positioned at a predetermined height. The restricting rollers 68 prevent the form of the roll sheet R from changing from R1 to R2 during its movement. That is, the form of the roll sheet R changes from R1 to R3. When a force for moving the roll sheet R further away from the ejection unit 5 is applied to the roll sheet R that is in the form of R3, the roll sheet R will be put into a proper state as shown by a solid line in FIG. 6, which means that it will not be put into a loop-like raised state. It is easy for the roll sheet R that is in such a proper state to guide itself into the guiding path 67 of the cutter unit 62. Therefore, the roll sheet R will be set at a proper position for cutting operation. When the restricting rollers 68 are in contact with the roll sheet R, they rotate around the Y axis to reduce friction between them and the roll sheet R. Therefore, the roll sheet R will not be scratched.

When the length of an ejected part of the roll sheet R, which is ejected from the ejection unit 5, reaches a predetermined value, the cutter unit 62 travels in the Y-axis direction as illustrated in FIG. 7B to perform cutting operation. When the cutter unit 62 moves toward the +Y side, the +Y side portion of the cutter holder 66 is brought into contact with the side portion 69A of the supporting plate 69, which is a component of the restricting member 61. Having the inclined shape, the side portion 69A allows the cutter unit 62 to move while pushing the supporting plate 69 out of the way and thus producing a +X directional force for moving the restricting member 61 from the first position A to the second position B.

Since the force acting toward the +X side is applied to the restricting member 61, as illustrated in FIGS. 3 and 4, the supporting plate 69 turns around the turning fulcrum shaft 70 extending in the Y-axis direction. For this reason, the restricting member 61 moves from the first position A, which is located inside the path of movement of the cutter unit 62, to the second position B, which is located outside the path of movement of the cutter unit 62. As explained above, when the cutter unit 62 performs cutting operation, it is brought into contact with the restricting member 61 to push the restricting member 61 out of the way, thereby moving the restricting member 61 from the first position A to the second position B. With such a structure, it is possible to move the restricting member 61 by utilizing the motive power of the cutter unit 62 without any need to provide a means for supplying motive power to the restricting member 61.

The cutter unit 62 moves forward while pushing the restricting member 61 out of the way to cut the roll sheet R. When the cutter unit 62 cuts the roll sheet R, the restricting rollers 68 of the restricting member 61 positioned at the second position B function to restrict the raising of a part of the roll sheet R that is now being cut (refer to FIG. 6). In addition, the restricting rollers 68 function to restrict the raising of an end of the roll sheet R after the cutting process due to repulsion (refer to the same).

After the completion of cutting operation, the cutter unit 62 stops in a state in which it is in contact with the supporting plate 69 of the restricting member 61 as illustrated in FIG. 7B. By controlling the operation of the cutter unit 62 as explained above, it is possible to prevent the restricting member 61 from moving from the second position B back to the first position A due to its own weight. Next, the cutter unit 62 performs returning operation. That is, the cutter unit 62 moves from the stop position back to the standby position shown in FIG. 7A. When the cutter unit 62 moves toward the standby position, the cutter holder 66 comes away from the supporting plate 69. Therefore, the restricting member 61, which has been pushed out of the way, automatically moves back to the first position A, that is, the optimum position at which the loop-like raising of the roll sheet R can be prevented most effectively, due to its own weight.

As explained in detail above, the cutting device 6 according to the present embodiment of the invention includes the restricting member 61 and the cutter unit 62 both of which are provided downstream of the ejection unit 5 that ejects the roll sheet R after recording processing. The restricting member 61 restricts a position in height of the ejected roll sheet R. The cutter unit 62 moves in a width direction, which is orthogonal to a direction of ejection of the roll sheet R, to cut the roll sheet R. The restricting member 61 moves between the first position A, which is located inside the path of movement of the cutter unit 62, and the second position B, which is located outside the path of movement of the cutter unit 62. Since the restricting member 61 is configured to be able to move between the position inside the path of movement of the cutter unit 62 and the position outside the path of movement of the cutter unit 62, it is possible to prevent the loop-like raising of the roll sheet R effectively inside the path of movement of the cutter unit 62 during the ejection of the roll sheet R and to get the restricting member 61 out of the way, that is, move it to the outside of the path of movement of the cutter unit 62, in the course of the cutting of the roll sheet R. Thus, with the structure disclosed in the present embodiment of the invention, it is possible to provide the cutting device 6 that prevents the roll sheet R (recording target medium) from being put into a loop-like raised state effectively without obstructing cutting operation and to provide the ink-jet printer 1 that is equipped with the cutting device 6.

### Second Embodiment

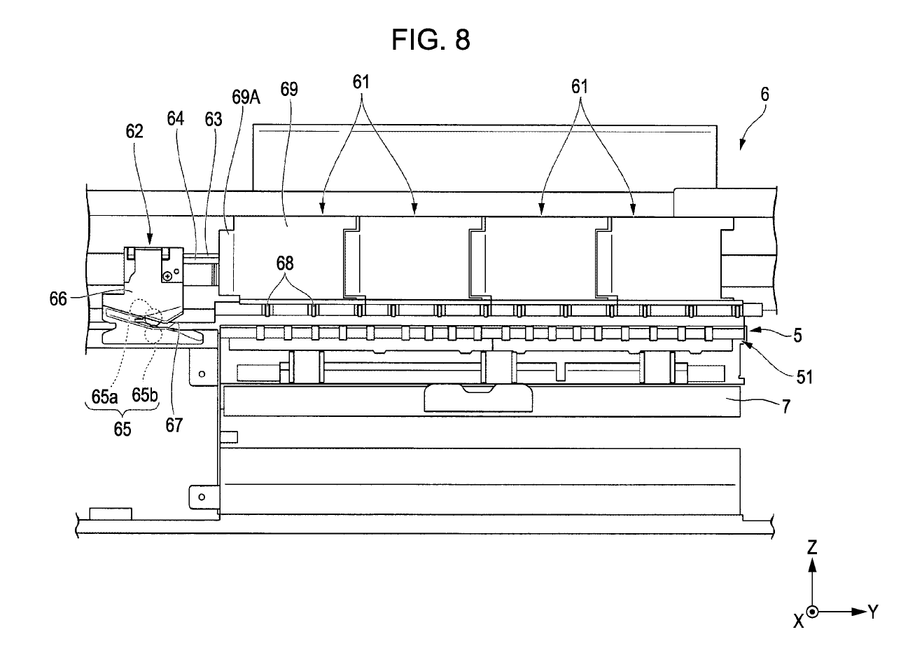

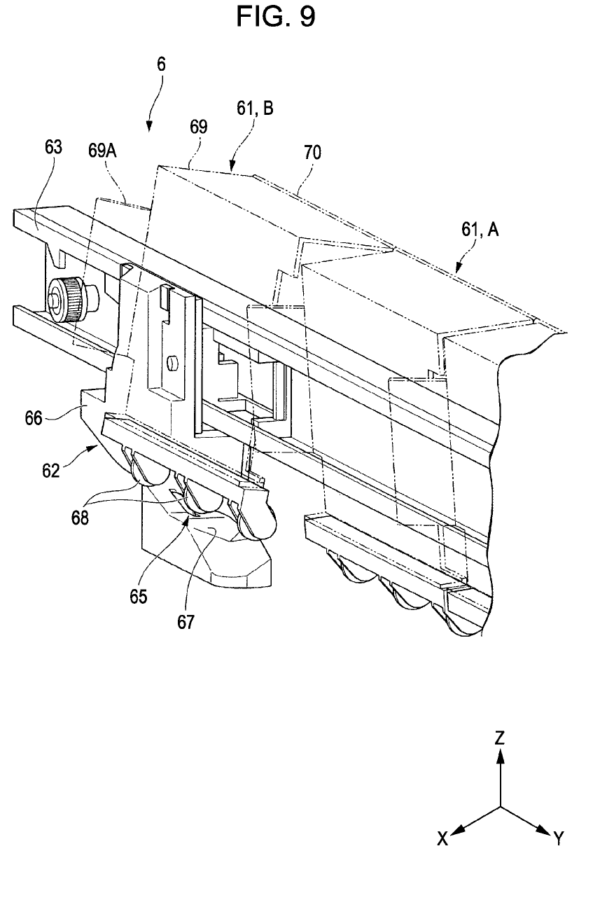

Next, a second embodiment of the invention is explained below. In the following description, the same reference numerals are used for components that are the same as or similar to those of the foregoing embodiment of the invention to simplify or omit explanation. FIG. 8 is a front view that schematically illustrates an example of the structure of the cutting device 6 according to a second embodiment of the invention, which is viewed from the ejection side along the direction of ejection (i.e., X-axis direction). FIG. 9 is a perspective view that schematically illustrates the restricting member 61 and the cutter unit 62 during cutting operation according to the second embodiment of the invention.

As illustrated in FIG. 8, the restricting member 61 according to the second embodiment of the invention is made up of a plurality of parts (hereinafter referred to as plural restricting members 61). The plural restricting members 61 are arranged along the path of movement of the cutter unit 62. The plural restricting members 61 are configured to be able to move independently of one another. With such a structure, in the course of the cutting of the roll sheet R, when the cutter unit 62 is brought into contact with a certain restricting member 61 to push this restricting member 61 out of the way, the other restricting members 61 that are not in contact with the cutter unit 62 remain at the first position A, thereby preventing the loop-like raising of the roll sheet R effectively inside the path of movement of the cutter unit 62. Therefore, the structure according to the second embodiment of the invention makes it possible to prevent the loop-like raising of the roll sheet R inside the path of movement of the cutter unit 62 at the optimum position even during cutting operation.

Note that the scope of the invention is not limited to any of the foregoing exemplary embodiments explained above with reference to the accompanying drawings. The shape of each of the constituent members described in the foregoing embodiments, a combination thereof, and the like are specified merely for the purpose of explanation. They may be modified, altered, changed, adapted, and/or improved within a range not departing from the gist and/or spirit of the invention apprehended by a person skilled in the art from explicit and implicit description given herein, for example, to satisfy design requirements.

In the foregoing embodiment of the invention, it is explained that the cutter unit 62 is brought into contact with the restricting member 61 to push the restricting member 61 out of the way, thereby moving the restricting member 61 from the first position A to the second position B. In addition, it is explained above that the restricting member 61 moves from the second position B back to the first position A due to its own weight. However, the scope of the invention is not limited to such an exemplary structure. For example, a means for driving the restricting member 61 may be provided. In such a modified structure, the restricting member 61 can move without using the motive power of the cutter unit 62.

In the foregoing embodiment of the invention, it is explained that the restricting member 61 includes the restricting rollers 68 that are set at the restricting positions to restrict the position in height of the roll sheet R. However, the scope of the invention is not limited to such an exemplary structure. For example, the restricting rollers 68 may be omitted. In such a modified structure, the arc-drawing end of the supporting plate 69 restricts the position in height of the roll sheet R directly.

In the foregoing embodiment of the invention, it is explained that, after the completion of cutting operation, the cutter unit 62 stops in a state in which it is in contact with the supporting plate 69 of the restricting member 61, thereby preventing the restricting member 61 from moving from the second position B back to the first position A due to its own weight. However, the scope of the invention is not limited to such an exemplary structure. For example, the supporting plate 69 may have an inclined plane not only at the −Y side but also at the +Y side. In such a modified structure, the cutter unit 62 moves while pushing the restricting member 61 out of the way not only during cutting operation but also during return operation.

In the foregoing embodiment of the invention, the ink-jet printer 1 is taken as an example of a recording apparatus. However, the scope of the invention is not limited thereto. For example, the invention can be applied to a copying machine, a fax machine, or the like.

What is claimed is:

1. A cutting apparatus comprising:
a restricting member that is provided downstream of an ejector that ejects a recording target medium after recording processing, the restricting member restricting a position in height of the ejected recording target medium; and
a cutting unit that is also provided downstream of the ejector and moves in a width direction, which is orthogonal to a direction of ejection of the recording target medium, to cut the recording target medium,
wherein the restricting member moves between a first position that is located inside a path of movement of the cutting unit and a second position that is located outside the path of movement of the cutting unit.

2. The cutting apparatus according to claim 1, wherein the restricting member moves between the first position and the second position as the cutting unit moves.

3. The cutting apparatus according to claim 1, wherein the restricting member is provided in substantially perpendicular orientation and/or in an at least partially suspended manner in a state in which the restricting member can rotate around a predetermined shaft; and the restricting member moves from the first position to the second position when the cutting unit is brought into contact with, and applies a pushing force to, the restricting member.

4. The cutting apparatus according to claim 3, wherein the restricting member has an inclined plane for producing a force for moving the restricting member from the first position to the second position when the cutting unit is brought into contact with, and applies the pushing force to, the inclined plane.

5. The cutting apparatus according to claim 3, wherein the first position is a position at which the restricting member is in a stable state due to its own weight; and the second position is a position at which the restricting member is in a state in which a moving force toward the first position is exerted on the restricting member due to its own weight.

6. The cutting apparatus according to claim 1, wherein the restricting member includes a roller that can rotate around a shaft extending in the width direction; and the roller is provided at a position for restricting the position in height of the recording target medium.

7. The cutting apparatus according to claim 1, wherein the restricting member includes a plurality of member portions that are arranged along the path of movement of the cutting unit; and the member portions are configured to be able to move independently of one another.

8. A recording apparatus comprising:
a recording section that performs recording on a recording target medium;
an ejecting section that ejects the recording target medium after the recording; and
a cutting apparatus provided downstream of the ejecting section, the cutting apparatus including:
a restricting member that is provided downstream of the ejecting section, the restricting member restricting a position in height of the ejected recording target medium; and
a cutting unit that is also provided downstream of the ejecting section and moves in a width direction, which is orthogonal to a direction of ejection of the recording target medium, to cut the recording target medium,
wherein the restricting member moves between a first position that is located inside a path of movement of the cutting unit and a second position that is located outside the path of movement of the cutting unit.

9. The recording apparatus according to claim 8, wherein the restricting member moves between the first position and the second position as the cutting unit moves.

10. The recording apparatus according to claim 8, wherein the restricting member is provided in substantially perpendicular orientation and/or in an at least partially suspended manner in a state in which the restricting member can rotate around a predetermined shaft; and the restricting member moves from the first position to the second position when the cutting unit is brought into contact with, and applies a pushing force to, the restricting member.

11. The recording apparatus according to claim 10, wherein the restricting member has an inclined plane for producing a force for moving the restricting member from the first position to the second position when the cutting unit is brought into contact with, and applies the pushing force to, the inclined plane.

12. The recording apparatus according to claim 10, wherein the first position is a position at which the restricting member is in a stable state due to its own weight; and the second position is a position at which the restricting member is in a state in which a moving force toward the first position is exerted on the restricting member due to its own weight.

13. The recording apparatus according to claim 8, wherein the restricting member includes a roller that can rotate around a shaft extending in the width direction; and the roller is provided at a position for restricting the position in height of the recording target medium.

14. The recording apparatus according to claim 8, wherein the restricting member includes a plurality of member portions that are arranged along the path of movement of the cutting unit; and the member portions are configured to be able to move independently of one another.
